(19) United States
(12) Patent Application Publication
(10) Pub. No.: US 2016/0177608 A1
(43) Pub. Date: Jun. 23, 2016

(54) Barrier Identification for Automated Configuration of Barrier Operator

(71) Applicant: The Chamberlain Group, Inc., Elmhurst, IL (US)

(72) Inventors: Rik Bruns, Belvidere, IL (US); Ira DaVall, Wheaton, IL (US); Ronald Seyk, Algonquin, IL (US)

(21) Appl. No.: 14/974,940

(22) Filed: Dec. 18, 2015

Related U.S. Application Data
(60) Provisional application No. 62/093,795, filed on Dec. 18, 2014.

(51) Int. Cl. E05F 1/00; E05F 15/00

(52) U.S. Cl. CPC E05F 1/002; E05F 15/00; E05Y 2900/106

(57) ABSTRACT

Configuration of a movable barrier operator is facilitated through communication with a module configured to substantially permanently affix to a barrier. The module contains information regarding the barrier in a manner to be accessible and transferable to a movable barrier operator configured to move the barrier. The movable barrier operator receives the information and automatically adjusts and sets barrier movement parameters for the movable barrier operator based on the information.

### CROSS-REFERENCE TO RELATED APPLICATION

This patent claims benefit under 35 U.S.C. §119(e) to U.S. Provisional Application No. 62/093,795 entitled “Barrier Identification for Automated Configuration of Barrier Operator,” filed Dec. 18, 2015, the content of which is incorporated herein by reference in its entirety.

### TECHNICAL FIELD

This invention relates generally to movable barriers and more specifically to automated barrier operators configured to move the movable barriers.

### BACKGROUND

Barriers such as garage doors come in wide variety of shapes, sizes, and weights and are installed in a wide variety of installation conditions. Although residential garage barriers generally come in a more limited range of sizes and weights that can be safely opened and closed by most residential garage barrier operators, commercial doors come in a wide variety of heights, widths, materials and weights that must be opened and closed to many different heights and over a wide range of speeds. This is true for other movable barriers and their operators, such as gate operators.

Because of this wide range of barriers, matching and installing commercial and industrial barrier operators (movable barrier operators) to the moved barrier is usually specific for each barrier. The operators need to be chosen and programmed to safely and efficiently open and close the commercial barrier installed with it. Some of the variables that need to be taken into account are: weight of the barrier, size of the barrier (width and height), material of the barrier, opening and closing speed requirements, speed variability including transition points along the barrier's travel, overhead horizontal and/or vertical lift, radius and/or tilt/angle of the track along which the barrier moves, counterweights used with the barrier, and the physical environment for the barrier (internal only, external, subject to high winds, grit, and the like).

All of these variables create complex installations that take a great deal of time and are highly dependent on the knowledge, skills, and experience of the installer. There is also the possibility that a key variable can be missed or entered incorrectly leading to unintended consequences.

In Europe, the barrier and operator are thought of as a system, and the installer is ultimately responsible for the installation and the operation of the entire system. Because of this, installations can be slow as the installer wants to be very sure everything is correct and that the installer captures the important variables identified and enters them correctly in the controller for the operator. This also creates an environment where installations can almost seem more like an art than a science and can create wide variations at installations.

In the United States, the barrier and operator are generally not considered as a combined system. Considering accountability, more parties are held responsible for problems or accidents involving commercial/industrial doors and operators (i.e., the installer, door manufacturer, and operator manufacturer). Because it is not thought of as a system, the various pieces are not always well matched or installed together in the most optimum manner. In fact, a system could be commissioned where the barrier is run in a manner that is not as the door and operator manufacturers intended.

### BRIEF DESCRIPTION OF THE DRAWINGS

The above needs are at least partially met through provision of the barrier identification for automated configuration of barrier operator described in the following detailed description, particularly when studied in conjunction with the drawings, wherein:

FIG. 1 comprises a perspective view of a movable barrier system as configured in accordance with various embodiments of the invention;

FIG. 2 comprises a block diagram of a movable barrier system as configured in accordance with various embodiments of the invention.

FIG. 3 comprises a flow chart of operation of a module to facilitate configuration of a movable barrier in accordance with various embodiments of the invention.

FIG. 4 comprises a flow chart of operation of a movable barrier in conjunction with a module in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, the described system will typically make the installation process for a movable barrier with an operator easier, shorten the time required for the install, and create and maintain a safe, efficient, and unified door/operator system as intended by the barrier and operator manufacturers.

Approaches provided herein generally relate to a module or “pod” that is connected to or integrated into the barrier. In one approach, the module is a digital device that contains relevant data about the barrier. The module could also be analog based, which could similarly be used for identification of barrier data using a specific analog value mapping scheme. For example, resistors can be used as unique identifiers of various combinations of the important variables.

The module can be connected to communicate with the operator using any known method. The interaction can be performed with any known wired or wireless communication method. For example, a cable can be run from the barrier to the operator or the module or barrier can have a transmitter integrated into it for communication with the barrier. The transmitter can periodically transmit the information. As yet another example, the module could include a label marked with the data. This marking could be a barcode or QR code as examples. In still another example, the module could include a bidirectional radio frequency identification (RFID) tag that the operator can use to receive the information about the barrier.

When an operator is installed, the module and operator can communicate with each other, and the module can provide the relevant data about the barrier to the operator. The operator can then use the data to configure its operation. If the operator does not sense the module then the operator can have a default to a specific set of parameters.

In one embodiment, the barrier data sent by the module to the operator is just about the barrier, and the operator can determine the barrier's type and/or physical characteristics. In such an example, the operator can be pre-programmed to know the proper default parameters for how to open and close that barrier type (speed profile, as but one example). The information on the kind of barrier and the barrier data may all be the same thing or they can be different sets of data. For example, if a barrier manufacturer makes one kind of barrier in only one size, weight, and the like, then that would be one unified set of data. A barrier manufacturer, however, may produce a kind of barrier (for instance, a high speed material based barrier) that is produced over a range of standard sizes, weights, and the like, in which case the kind of barrier would be one data set and the barrier specifics would be the other data set (eight feet wide vs. 12 feet wide, or the like).

In still another approach, the module contains the barrier data and data pertaining to various operators. In this approach, the module may communicate to the operator both operator data and corresponding barrier data. For example, the module may convey a message to the effect of: “If you are a certain specific operator model XYZ, then use the following parameters and settings: . . . ”

In still another approach, an installer installing the module inputs into the module data pertaining to the operator to be used in the system. The input data may be, for example, the operator make and model. Using this input data, the module can communicate the proper corresponding parameters and settings for the operator to use. An additional variation can have the operator tell the module the operator's model, and the module can choose the appropriate data to send to the operator.

In some variations, the installer can accept the default parameters and operating procedures and also make changes to the defaults. This allows the installer to make appropriate changes based on the physical installation site or desired performance needs.

With respect to the module, typically, the module will not be removable from the barrier for various reasons. First, moving a module from one barrier onto another barrier creates a potential problem if the two barriers require different default parameters. Second, if an operator needs to be replaced or repaired in the future, the module will still be on the barrier to provide the appropriate data to the operator. Third, having the module substantially permanently affixed to the barrier (i.e., connected in a manner that removal requires extraordinary effort and/or will damage the module, the barrier, or both) can provide a safety measure in that the operator may be able to periodically confirm presence of the module as a way to confirm that a current set of operating parameters are still valid. This approach would identify a change or replacement of the barrier such that the operator can respond accordingly. As an example, a barrier may be replaced after being damaged. If the replacement barrier is of a different characteristic, the operator can respond by any of a number of possible actions. For instance, the operator could automatically require execution of a setup procedure and/or automatically modify its operation parameters in response to detecting a change of door information.

The connection between the module and the barrier can accomplished in number of ways including bolting, welding, using permanent adhesive, or the like. In one approach, the module and barrier are keyed so that the module would substantially only readily mount to a barrier with characteristics reflected in the information stored in or on the module. In another approach, the module can be configured in such a way that the module will not send or display the information when not substantially permanently affixed to the barrier. In the case of a module to be scanned such as a QR code or barcode, the module can be mounted such that removal from the barrier destroys the QR code or barcode. For an electric module, an activation switch can be disposed on the module such that it will not display or send its information unless that activation switch is actuated through engagement with the barrier. This actuation switch could be a mechanical switch actuated through physical engagement with the barrier and/or an electric switch that is actuated through electrical engagement with an electrical module or aspect on the barrier. Other options are possible.

With respect to the communication between the module and the operator, such communications can be authenticated or encrypted to prevent outside actors from changing operator parameters. Unauthenticated or unencrypted communication could be possible, especially in a wired approach.

Those skilled in the art will appreciate that the above-described processes are readily enabled in the module and movable barrier operator using any of a wide variety of available and/or readily configured platforms, including partially or wholly programmable platforms as are known in the art or dedicated purpose platforms as may be desired for some applications. For example, a processing device can be installed in either or both of the module and movable barrier operator to facilitate the described processes. Those skilled in the art will recognize and appreciate that such a processor device can comprise a fixed-purpose hard-wired platform or can comprise a partially or wholly programmable platform. All of these architectural options are well known and understood in the art and require no further description here.

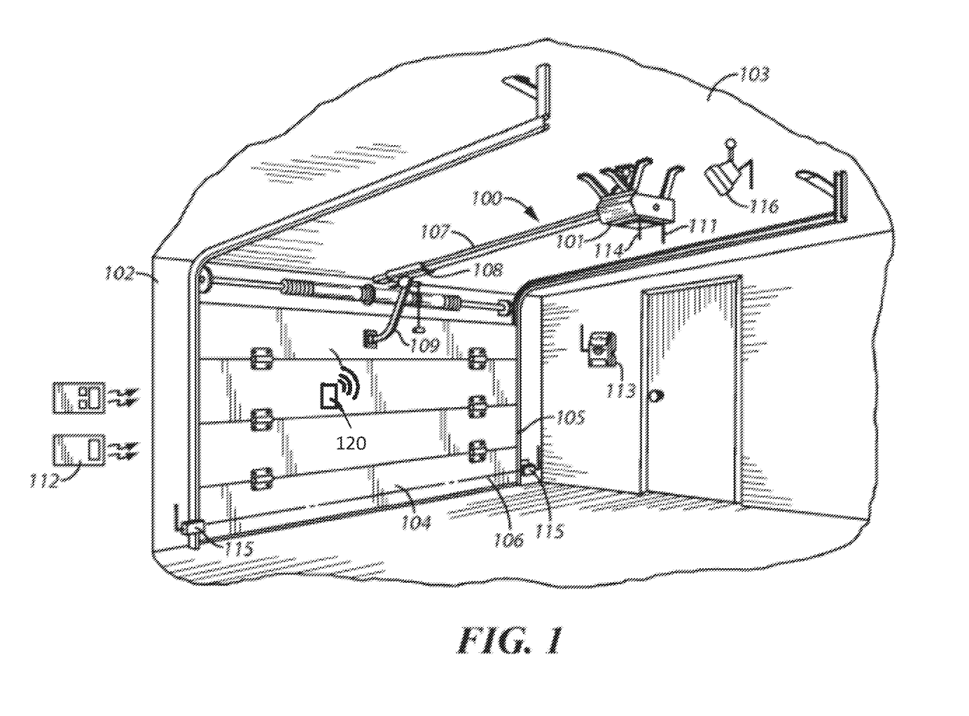

FIG. 1 provides an illustration of one example implementation. A barrier movement system 100 comprises, in part, a movable barrier operator 101 positioned within a garage 102 or similar space. This movable barrier operator 101 mounts to the garage ceiling 103 and serves to control and effect selective movement of a selectively movable barrier comprising, in this illustrative example, a multi-panel garage door 104. The multi-panel garage door 104 includes a plurality of rollers (not shown) rotatably confined within a pair of tracks 105 positioned adjacent to and on opposite sides of the garage opening 106.

The movable barrier operator 101 includes a head unit having a motive component such as an electric motor (not shown) to provide motion to the garage door 104 via a rail assembly 107. The rail assembly 107 in this example includes a trolley 108 for releasable connection of the head unit to the garage door 104 via an arm 109. The arm 109 connects to an upper portion 110 of the garage door 104. The trolley 108 effects the desired movement of the door 104 via the arm 109 via a transmission that can be an endless chain, belt, or screw drive, all of which are well know in the industry. As an alternative, another head unit that is well known in the industry is a jackshaft operator that moves the barrier by affecting a counter balance system.

The head unit includes a radio frequency receiver (not shown) having an antenna 111 to facilitate receiving coded radio frequency transmissions from one or more radio transmitters 112. These transmitters 112 may include portable transmitters (such as keyfob-style transmitters) or keypad transmitters (such as those often installed in automobile sun visors). The radio receiver typically connects to a processor (not shown) in the head unit that interprets received signals and responsively controls other portions of the movable barrier operator 101.

The head unit also includes a radio frequency transmitter (not shown) having an antenna 114 to facilitate transmitting coded radio frequency transmissions to and/or receive transmissions from one or more one way or two-way remote platforms including the module 120 as described herein. In many application settings the radio frequency receiver and the radio frequency transmitter will operate using non-overlapping and considerably different bands. Together, this receiver and transmitter comprise a transceiver.

An end-user interface 113 such as a push button-based wall control unit or liquid crystal display unit can comprise one of the aforementioned two-way remote platforms and can wirelessly communicate with the head unit to effect control of a movable barrier operator motor and other components. So configured, for example, an end user can assert the end-user interface 113 to signal to the movable barrier operator 101 that the barrier 104 should now be moved from an opened position to a closed position or change operation settings for the movable barrier operator 101.

An obstacle detector 115 can also comprise one of the aforementioned two-way remote platforms and can also wirelessly communicate with the head unit. The obstacle detector can employ, for example, optical (such as infrared-pulsed beams) approaches to detect when the garage door opening 106 is blocked. The obstacle detector 115 can then wirelessly signal the movable barrier operator 101 regarding the blockage. The latter can then, for example, cause a reversal or opening of the door 104 to avoid contacting the obstacle.

A light fixture 116 can also comprise one of the aforementioned two-way remote platforms and hence can also wirelessly communicate with (or via) the head unit. So configured, the movable barrier operator 101 can selectively cause the light fixture 116 to provide a source of light if and as appropriate.

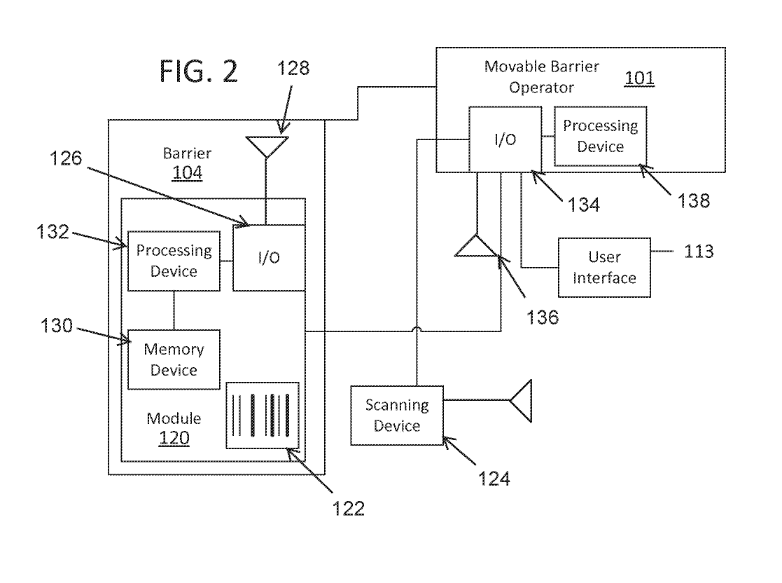

FIG. 2 illustrates several possible variations on the module 120 and movable barrier operator 101 and the modes of communication between the two as described herein. The module 120 is connected to the barrier 104, and is preferably substantially permanently affixed to the barrier 104. For example, the module 120 may be connected to or integrated into the barrier 104 by bolting, welding, or using permanent adhesive. The module 120 contains information regarding the barrier 120. This information is contained in the module 120 in a manner to be accessible and transferable to the movable barrier operator 101 that is configured to move the barrier 104.

In one approach, the module 120 includes a displayed code 122 readable by a scanning device 124. In response to reading the displayed code 122, the scanning device 124 obtains the information regarding the barrier 104. In another approach, the module 120 includes an interface 126 that may include a radio frequency device. In one aspect, the radio frequency device transmits the information regarding the barrier 104 periodically. In another aspect, the radio frequency device is a responsive radio frequency device configured to transmit the information regarding the barrier 104 in response to receipt of a query. The query may be, for example, a query from the movable barrier operator 101.

The information regarding the barrier 104 includes, for example, identification information for the barrier 104 to which the module 120 is substantially permanently affixed. The information may also include information regarding one or more physical characteristics of the barrier 104, or information regarding movable barrier operator operation parameters for the barrier 104.

The module 120 preferably includes a memory device 130. The memory device 130 in some aspects stores the information regarding the barrier 104. The memory device 130 is configured to make the information accessible by a wired or wireless connection to the module 120.

In some approaches, the module 120 includes a module processing device 132 that receives information pertaining to the movable barrier operator 101. The information may be received, for example, from the movable barrier operator 101 or an installer of the module 120. The module processing device 132 may effect sending (and/or displaying) operation parameter settings specific to the movable barrier operator 101 identified by the barrier operator information and the barrier 104 on which the module 120 is fixed. The module processing device 132 may send the operation parameter settings in a format specific for receipt by the movable barrier operator 101 identified by the barrier operator information.

The movable barrier operator 101 comprises an interface 134 that may include, for example, a wireless communication device 136. The wireless communication device 136 may be configured to periodically send a query to the module 120. The interface 134 is also preferably configured to receive a communication (for example, a wireless communication) from the module 120 that includes information regarding the barrier 104.

As discussed, the movable barrier operator 101 may include a user interface 113. The user interface 113 is preferably configured to allow a user to enter information for use by the movable barrier operator 101 to automatically adjust and set barrier movement parameters for the movable barrier operator 101 based on the information regarding the barrier 104.

In some aspects, the movable barrier operator 101 is configured to allow a user to input modifications to the barrier movement parameters previously set based on the information regarding the barrier 104. This may be performed, for example, in response to user inputs received at the user interface 113.

The movable barrier operator 101 may further include a processing device 138 configured to receive the information, for example, from the module 120. The processing device 138 may further be configured to automatically adjust and set barrier movement parameters for the movable barrier operator 101 based on the information regarding the barrier 104.

Any combination of these various described aspects may be implemented in a given application.

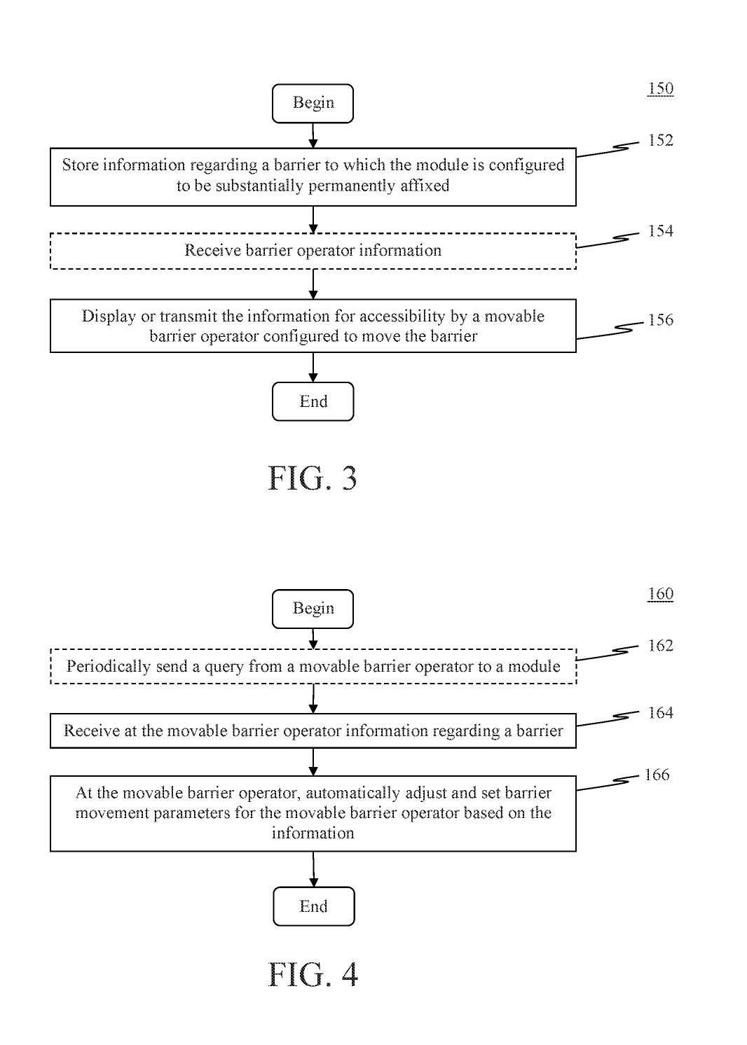

Turning now to FIG. 3, a method 150 of operation of a module to facilitate configuration of a movable barrier operator includes storing 152 information regarding a barrier to which the module is configured to be substantially permanently affixed. In some aspects, the method 150 further includes receiving 154 barrier operator information.

The method 150 further includes displaying 156 or transmitting the information for accessibility by a movable barrier operator configured to move the barrier. In some approaches, the displaying 156 or transmitting the information includes sending or displaying operation parameter settings specific for the movable barrier operator identified by the barrier operator information and the barrier on which the module is fixed.

The displaying 156 or transmitting the information may include, for example, displaying a code readable by a scanning device. In response, the scanning device obtains the information regarding the barrier. In another approach, the displaying 156 or transmitting the information includes transmitting the information regarding the barrier periodically from a radio frequency device. In still another approach, the displaying 156 or transmitting the information includes transmitting the information regarding the barrier from a responsive radio frequency device in response to receipt of a query. In yet another approach, the displaying 156 or transmitting the information includes transmitting the information from a memory device storing the information from a wired connection to the module.

In still other approaches, the displaying 156 or transmitting the information includes sending the operation parameter settings in a format specific for receipt by the movable barrier operator identified by the barrier operator information.

Turning now to FIG. 4, a method 160 of operation of a movable barrier operator in conjunction with a module substantially permanently affixed to a barrier is provided. In an optional approach, the movable barrier operator periodically sends 162 a query to the module. The method 160 includes receiving 164 at the movable barrier operator information regarding the barrier. The receiving 164 of the information may be in response to a query sent by the movable barrier operator to the module. The movable barrier operator may receive the information regarding the barrier via a wired or wireless communication from the module. In some aspects, the receiving 164 of the information includes receiving the information through a user interface at the movable barrier operator.

The receiving 164 of the information, in one example, includes receiving identification information for the barrier to which the module is substantially permanently affixed. In another example, the receiving 164 of the information includes receiving information regarding one or more physical characteristics of the barrier to which the module is substantially permanently affixed. In yet another example, the receiving 164 of the information includes receiving information regarding movable barrier operator operation parameters for the barrier to which the module is substantially permanently affixed.

The method 160 further includes, at the movable barrier operator, automatically adjusting and setting 166 barrier movement parameters for the movable barrier operator based on the information. In some aspects, this is performed in response to the information received from the module. In other aspects, this is performed in response to the information received through the user interface.

The method 160 may further include, at the movable barrier operator, receiving a user modification to the barrier movement parameters previously set based on the information. The user modification may be provided, for example, via user inputs received at the user interface.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

1. An apparatus for facilitating configuration of a movable barrier operator, the apparatus comprising:
a module configured to substantially permanently affix to a barrier, the module containing information regarding the barrier, the information being contained in the module in a manner to be accessible and transferable to a movable barrier operator configured to move the barrier.

2. The apparatus of claim 1 wherein the module comprises one or more of:
a displayed code readable by a scanning device in response to which the scanning device obtains the information regarding the barrier;
a radio frequency device configured to transmit the information regarding the barrier periodically;
a responsive radio frequency device configured to transmit the information regarding the barrier in response to receipt of a query;
a memory device storing the information and configured to make the information accessible by a wired connection to the module.

3. The apparatus of claim 1 wherein the module comprises a module processing device configured to receive barrier operator information and effect sending or displaying of operation parameter settings specific for the movable barrier operator identified by the barrier operator information and the barrier on which the module is fixed.

4. The apparatus of claim 3 wherein the module processing device is configured to effect sending the operation parameter settings in a format specific for receipt by the movable barrier operator identified by the barrier operator information.

5. The apparatus of claim 1 further comprising the movable barrier operator, wherein the movable barrier operator comprises an operator processing device configured to receive the information and automatically adjust and set barrier movement parameters for the movable barrier operator based on the information.

6. The apparatus of claim 5 wherein the movable barrier operator comprises a wireless communication device configured to periodically send a query to the module and to receive a wireless communication from the module including the information.

7. The apparatus of claim 5 further comprising a user interface for the movable barrier operator, wherein the user interface is configured to allow a user to enter the information for use by the movable barrier operator to automatically adjust and set the barrier movement parameters for the movable barrier operator based on the information.

8. The apparatus of claim 7 wherein the movable barrier operator is configured to allow a user to enter modifications to the barrier movement parameters previously set based on the information in response to user inputs received at the user interface.

9. The apparatus of claim 1 wherein the information comprises one or more of:
identification information for the barrier to which the module is substantially permanently affixed;
information regarding one or more physical characteristics of the barrier to which the module is substantially permanently affixed;
information regarding movable barrier operator operation parameters for the barrier to which the module is substantially permanently affixed.

10. The apparatus claim 1 further comprising the barrier having the module substantially permanently fixedly attached thereto.

11. An apparatus for facilitating configuration of a movable barrier operator using a module substantially permanently affixed to a barrier, the module containing information regarding the barrier, the information being contained in a manner to be accessible and transferable to a movable barrier operator configured to move the barrier, the apparatus comprising: the movable barrier operator, wherein the movable barrier operator comprises a processing device configured to receive the information and automatically adjust and set barrier movement parameters for the movable barrier operator based on the information.

12. The apparatus of claim 11 wherein the movable barrier operator comprises a wireless communication device configured to periodically send a query to the module and to receive a wireless communication from the module including the information.

13. The apparatus of claim 11 further comprising a user interface for the movable barrier operator, wherein the user interface is configured to allow a user to enter the information for use by the movable barrier operator to automatically adjust and set the barrier movement parameters for the movable barrier operator based on the information.

14. The apparatus of claim 13 wherein the movable barrier operator is configured to allow a user to enter modifications to the barrier movement parameters previously set based on the information in response to user inputs received at the user interface.

15. The apparatus of claim 11 wherein the information comprises one or more of:
identification information for the barrier to which the module is substantially permanently affixed;
information regarding one or more physical characteristics of the barrier to which the module is substantially permanently affixed;
information regarding movable barrier operator operation parameters for the barrier to which the module is substantially permanently affixed.

16. A method of operation of a module to facilitate configuration of a movable barrier operator, the method comprising:
storing information regarding a barrier to which the module is configured to be substantially permanently affixed;
displaying or transmitting the information for accessibility by a movable barrier operator configured to move the barrier.

17. The method of claim 16 wherein the displaying or transmitting the information comprises one or more of:
displaying a code readable by a scanning device in response to which the scanning device obtains the information regarding the barrier;
transmitting the information regarding the barrier periodically from a radio frequency device;
transmitting the information regarding the barrier from a responsive radio frequency device in response to receipt of a query;
transmitting the information from a memory device storing the information from a wired connection to the module.

18. The method of claim 16 further comprising:
receiving barrier operator information; and sending or displaying operation parameter settings specific for the movable barrier operator identified by the barrier operator information and the barrier on which the module is fixed.

19. The method of claim 18 further comprising sending the operation parameter settings in a format specific for receipt by the movable barrier operator identified by the barrier operator information.

20. A method of operation of a movable barrier operator in conjunction with a module substantially permanently affixed to a barrier, the module containing information regarding the barrier, the information being contained in a manner to be accessible and transferable to a movable barrier operator configured to move the barrier, the method comprising:
the movable barrier operator receiving the information; and
the movable barrier operator automatically adjusting and setting barrier movement parameters for the movable barrier operator based on the information.

21. The method of claim 20 further comprising:
the movable barrier operator periodically sending a query to the module; and
the movable barrier operator receiving a wireless communication from the module including the information.

22. The method of claim 20 further comprising:
the movable barrier operator receiving the information through a user interface at the movable barrier operator; and
the movable barrier operator automatically adjusting and setting the barrier movement parameters for the movable barrier operator based on the information received through the user interface.

23. The method of claim 22 further comprising the movable barrier operator allowing a user to enter modifications to the barrier movement parameters previously set based on the information in response to user inputs received at the user interface.

24. The method of claim 20 wherein the receiving the information comprises one or more of:
receiving identification information for the barrier to which the module is substantially permanently affixed;
receiving information regarding one or more physical characteristics of the barrier to which the module is substantially permanently affixed;
receiving information regarding movable barrier operator operation parameters for the barrier to which the module is substantially permanently affixed.
